(19) United States
(12) Patent Application Publication
(10) Pub. No.: US 2007/0180261 A1
(43) Pub. Date: Aug. 2, 2007

(54) Biometric template protection and feature handling

(75) Inventors: Antonius Hermanus Maria Akkermans, Eindhoven (NL); Geert Jan Schrijen, Eindhoven (NL); Pim Theo Tuyls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,044

(22) PCT Filed: Jun. 2, 2005
(86) PCT No.: PCT/IB05/51804

§ 371 Date: Dec. 5, 2006

(30) Foreign Application Priority Data
Sep. 10, 2004 (EP) 04104386.0
Dec. 10, 2004 (EP) 04106480.9
Jun. 9, 2004 (EP) 04102609.7

(51) Int. Cl. H04K 1/00; G06F 12/14; H04L 9/00; G06F 11/30; H04L 9/32

(52) U.S. Cl. 713/186; 713/194

(57) ABSTRACT

The present invention relates to a method and a system of verifying the identity of an individual by employing biometric data associated with the individual while providing privacy of said biometric data. A basic idea of the present invention is to represent a biometric data set X_{FP} with a feature vector. A number of sets X_{FP1}, X_{FP2}, . . . X_{FPm} of biometric data and hence a corresponding number of feature vectors is derived, and quantized feature vectors X₁, X₂, . . . , Xₘ are created. Then, noise robustness of quantized feature components is tested. A set of reliable quantized feature components is formed, from which a subset of reliable quantized feature components is randomly selected. A first set W1 of helper data is created from the subset of selected reliable quantized components. The helper data W1 is subsequently used in a verification phase to verify the identity of the individual.

The present invention relates to a method and a system of verifying the identity of an individual by employing biometric data associated with the individual while providing privacy of said biometric data.

Authentication of physical objects may be used in many applications, such as conditional access to secure buildings or conditional access to digital data (e.g. stored in a computer or removable storage media), or for identification purposes (e.g. for charging an identified individual for a particular activity).

The use of biometrics for identification and/or authentication is to an ever-increasing extent considered to be a better alternative to traditional identification means such as passwords and pin-codes. The number of systems that require identification in the form of passwords/pin-codes is steadily increasing and, consequently, so is the number of passwords/pin-codes that a user of the systems must memorize. As a further consequence, due to the difficulty in memorizing the passwords/pin-codes, the user writes them down, which makes them vulnerable to theft. In the prior art, solutions to this problem have been proposed, which solutions involve the use of tokens. However, tokens can also be lost and/or stolen. A more preferable solution to the problem is the use of biometric identification, wherein features that are unique to a user such as fingerprints, irises, ears, faces, etc. are used to provide identification of the user. Clearly, the user does not lose or forget his/her biometric features, neither is there any need to write them down or memorize them.

The biometric features are compared to reference data. If a match occurs, the user is identified and can be granted access. The reference data for the user has been obtained earlier (during a so-called enrollment phase) and is stored securely, e.g. in a secure database or smart card. When authentication of the user is undertaken, the user claims to have a certain identity and an offered biometric template is compared with a stored biometric template that is linked to the claimed identity, in order to verify correspondence between the offered and the stored template. When identification of the user is effected, the offered biometric template is compared with all stored available templates, in order to verify correspondence between the offered and stored template. In any case, the offered template is compared to one or more stored templates.

Whenever a breach of secrecy has occurred in a system, for example when a hacker has obtained knowledge of secrets in a security system, there is a need to replace the (unintentionally) revealed secret. Typically, in conventional cryptography systems, this is done by revoking a revealed secret cryptographic key and distributing a new key to the concerned users. In case a password or a pin-code is revealed, a new one is selected to replace it. In biometric systems, the situation is more complicated, as the corresponding body parts obviously cannot be replaced. In this respect, most biometric data are static. Hence, it is important to develop methods to derive secrets from (generally noisy) biometric measurements, with a possibility to renew the derived secret, if necessary. It should be noted that biometric data is a good representation of the identity of an individual, and unauthenticated acquirement of biometric data associated with an individual can be seen as an electronic equivalent of stealing the individual's identity. After having acquired appropriate biometric data identifying an individual, the hacker may impersonate the individual whose identity the hacker acquired. Moreover, biometric data may contain sensitive and private information on health conditions. Hence, the integrity of individuals employing biometric authentication/identification systems must be safeguarded.

As biometric data provide sensitive information about an individual, there are privacy problems related to the management and usage of biometric data. For example, in prior art biometric systems, a user must inevitably trust the biometric systems completely with regard to the integrity of her biometric template. During enrollment—i.e. the initial process when an enrolment authority acquires the biometric template of a user—the user offers her template to an enrolment device of the enrolment authority that stores the template, possibly encrypted, in the system. During verification, the user again offers her template to the system, the stored template is retrieved (and decrypted if required) and matching of the stored and the offered template is effected. It is clear that the user has no control of what is happening to her template and no way of verifying that her template is treated with care and is not leaking from the system. Consequently, she has to trust every enrolment authority and every verifier with the privacy of her template. Although these types of systems are already in use, for example in some airports, the required level of trust in the system by the user makes widespread use of such systems unlikely.

Cryptographic techniques to encrypt or hash the biometric templates and perform the verification (or matching) on the encrypted data such that the real template is never available in the clear can be envisaged. However, cryptographic functions are intentionally designed such that a small change in the input results in a large change in the output. Due to the very nature of biometrics and the measurement errors involved in obtaining the offered template as well as the stored template due to noise-contamination, the offered template will never be exactly the same as the stored template and therefore a matching algorithm should allow for small differences between the two templates. This makes verification based on encrypted templates problematic.

“Capacity and Examples of Template-Protecting Biometric Authentication Systems” by Pim Tuyls and Jasper Goseling, Philips Research, discloses a biometric authentication system in which there is no need to store original biometric templates. Consequently, the privacy of the identity of an individual using the system may be protected. The system is based on usage of helper data schemes (HDS). In order to combine biometric authentication with cryptographic techniques, helper data is derived during the enrolment phase. The helper data guarantees that a unique string can be derived from the biometrics of an individual during the authentication as well as during the enrolment phase. Since the helper data is stored in a database, it is considered to be public. In order to prevent impersonation, reference data which is statistically independent of the helper data, and which reference data is to be used in the authentication stage, is derived from the biometric. In order to keep the reference data secret, the reference data is stored in hashed form. In this way impersonation becomes computationally infeasible.

A problem that remains in the disclosed helper data scheme is that it is problematic to generate reference data that has a sufficient length and at the same time has a low false rejection rate (FRR). An FRR which is not sufficiently low has the effect that failure to authenticate individuals will occur at an unacceptably high rate, even though the individuals actually are authorized. The FRR is a very important parameter in terms of facilitating acceptance of biometric systems. Another important parameter, which value also should be low, is the false acceptance rate (FAR). The FAR is a measure of the probability that two different biometric templates, which do not originate from the same individual, are considered to match each other. A trade-off should made between these two parameters, as a lower FRR will result in a higher FAR, and vice versa. Another problem with the above described helper data scheme is that a hashed copy of the reference value has to be publicly available, which means that the scheme is not secure if the hash function is reversible or if the hash function is not collision-resistant.

An object of the present invention is thus to provide a system for biometric identification/authentication that provides privacy of the identity of the individual while at the same time accomplishing a low false rejection rate (FRR) and a low false acceptance rate (FAR) in the biometric system.

This object is attained by a method of verifying the identity of an individual by employing biometric data associated with the individual, which method provides privacy of said biometric data according to claim 1 and a system for verifying the identity of an individual by employing biometric data associated with the individual, which system provides privacy of said biometric data according to claim 23.

According to a first aspect of the present invention, there is provided a method comprising the steps of deriving a plurality of sets of biometric data associated with the individual, each set comprising a number of feature components, quantizing the feature components of each set of derived biometric data, whereby a corresponding number of sets of quantized biometric data comprising a number of quantized feature components is created, determining reliable quantized feature components by analyzing a noise robustness criterion, which criterion implies that differences in the values of feature components with the same position in the respective sets of quantized biometric data should lie within a predetermined range for the components to be considered reliable, and creating a first set of helper data, which is to be employed in the verification of the identity of the individual, from said at least a subset of said reliable quantized feature components, wherein processing of biometric data of the individual is performed in a secure, tamper-proof environment, which is trusted by the individual.

According to a second aspect of the present invention, there is provided a system comprising means for deriving a plurality of sets of biometric data associated with the individual, each set comprising a number of feature components, and for quantizing the feature components of each set of derived biometric data, whereby a corresponding number of sets of quantized biometric data comprising a number of quantized feature components is created, means for determining reliable quantized feature components by analyzing a noise robustness criterion, which criterion implies that differences in the values of feature components with the same position in the respective sets of quantized biometric data should lie within a predetermined range for the components to be considered reliable, and for creating a first set of helper data, which is to be employed in the verification of the identity of the individual, from said at least a subset of said reliable quantized feature components, wherein the system is arranged such that processing of biometric data of the individual is performed in a secure, tamper-proof environment which is trusted by the individual.

A basic idea of the present invention is to provide privacy of the individual's biometric template while not erroneously rejecting authorized individuals, i.e. a low FRR is desirable. Initially, during an enrolment phase, a plurality in of sets X_{FP} of biometric data associated with an individual is derived. These sets of biometric data may be derived from a physical feature of the individual such as the individual's fingerprint, iris, face, voice, etc. Each biometric data set X_{FP} is represented by a feature vector, which comprises a number k of feature components. For a specific individual, a number m of measurements of the individual's physical feature is undertaken, which results in a corresponding number of sets X_{FP1}, X_{FP2}, . . . , X_{FPm} of biometric data and hence a corresponding number of feature vectors. The feature components are quantized, and quantized feature vectors X₁, X₂, . . . , Xₘ (also comprising k components) are hence created.

Then, reliable components are selected by testing noise robustness of quantized feature components. If, for the in different measurements of the biometric data of a particular individual, differences in the values of quantized feature components with the same position in the respective quantized feature vectors lies within a predetermined range, the quantized feature components are defined as reliable. Hence, if the values of the quantized feature components with corresponding locations in the quantized feature vectors are sufficiently close to each other, the quantized feature components (and thus the associated measured feature components) are considered reliable. Each quantized component has a resolution of n bits.

A higher value of m denotes a higher level of security in the system, i.e. a greater number of measured feature components must resemble each other to a sufficient extent to be considered reliable, and the number i of reliable quantized feature components per individual may differ. The number i of reliable quantized feature components forms a set from which at least a subset of reliable quantized feature components is randomly selected. This subset comprises j reliable components. A first set W1 of helper data is created from the subset of selected reliable quantized components and comprises j components. The first set W1 of helper data is then centrally stored. The largest number of reliable quantized feature components that may be used to create the helper data W1 is attained when j=i. The helper data W1 is subsequently used in a verification phase to verify the identity of the individual.

Note that processing of the biometric data of the individual, or security-sensitive data related to the biometric data, must be performed in a secure, tamper-proof environment, which is trusted by the individual, such that the biometric data of the individual is not revealed. Moreover, as previously mentioned, in case the individual is to be authenticated, identity data is provided to the system together with the offered biometric template, in order for the system to find the stored biometric template that is linked to the identity data. In case the individual is to be identified, the offered biometric template is compared with all stored available templates to find a match, and the provision of identity data is consequently not necessary.

The present invention is advantageous for a number of reasons. Firstly, processing of security sensitive information is performed in a secure, tamper-proof environment which is trusted by the individual. This processing, combined with utilization of a helper data scheme, enables set up of a biometric system where the biometric template is available in electronic form only in the secure environment, which typically comes in the form of a tamper-resistant user device employed with a biometric sensor, e.g. a sensor-equipped smart card. Moreover, electronic copies of the biometric templates are not available in the secure environment permanently, but only when the individual offers her template to the sensor. Secondly, the FRR may be adjusted by altering the quantization resolution n. The lower the resolution n, the lower the FRR. A lower resolution in the quantized feature components has the effect that a larger amount of noise is allowed in the measurement of feature components, while still considering the resulting feature components to be reliable. A trade-off must be made when determining the quantization resolution. While a low FRR is desired, it should be clearly understood that a too low resolution will have the effect that when biometric data sets pertaining to different individuals is quantized, the sets may differ but still be quantized to the same value. This has the effect that the FAR becomes higher. Thirdly, by choosing the number k of components in the feature vectors to be large, helper data W1 of a sufficient length may be generated.

According to an embodiment of the invention, an average value is determined for each feature component. The average value for each component is determined by calculating the average value of the measured feature components that have the same position in the respective feature vectors. The average value of each feature component is calculated from the respective measured feature components of all individuals (or at least a major part of individuals), which are enrolled in the system. Moreover, the average value for the respective components will be the same for all individuals that are enrolled in the system. From each feature component of the individual, the corresponding determined average value is subtracted, and the result of the subtraction is quantized into a resolution of n bits.

According to another embodiment of the present invention, the first set W1 of helper data is configured to comprise a number j of components, wherein each component in the first set of helper data is assigned a value that is equal to the position of the respective reliable quantized feature components in the sets X of quantized biometric data. Advantageously, a set W1 of helper data has been generated, which set is arranged such that no information about the biometric data is revealed by studying the helper data.

According to yet another embodiment of the present invention, a set X′ of data comprising the selected reliable quantized feature components is created and a secret value S is generated and encoded to create a codeword C having a length equal to the set X′ of data comprising the selected reliable quantized feature components. Further, a second set W2 of helper data is created by combining the codeword and the set of data comprising the selected reliable quantized feature components by using a combination function such as an XOR function. It should be understood that other appropriate combining functions alternatively may be used. If X′ for example comprises j components, wherein each component value ranges from 0 to 6, a combining function in the form of a modulo 7 operation can be employed. The second set W2 of helper data is then created as W2=X′+C mod 7 (calculated for each component). Preferably, functions K(a, b) which are invertible for every b are used. For example, K(a, b)=d=a+b is such a function, since for any b, the inverse function K(d, b)=d−b=a exists.

The secret value S is cryptographically concealed F(S) and centrally stored together with W2. The secret value is preferably cryptographically concealed by means of a one-way hash function, but any other appropriate cryptographic function may be used, as long as the secret value is concealed in a manner such that it is computationally infeasible to create a plain text copy of it from the cryptographically concealed copy. It is, for example, possible to use a keyed one-way hash function, a trapdoor hash function, an asymmetric encryption function or even a symmetric encryption function. This is advantageous since, in the prior art, the secret value is typically generated from the biometric data of the individual. The secret value is required in the verification phase, but the biometric data of the individual cannot be revealed from the secret data.

According to further embodiments of the present invention, a verification set Y_{FP} of biometric data associated with the individual is derived. Each set comprises a number k of feature components which are quantized into a verification set Y of quantized biometric data comprising k quantized feature components. Reliable components are selected in the verification set of quantized biometric data by having the first set W1 of helper data indicate the reliable components. Thereby, a verification set Y′ of selected reliable quantized feature components is created.

According to still further embodiments of the present invention, a second codeword Z is created by XORing the second set W2 of helper data and the verification set Y′ of selected reliable quantized feature components. Thereafter, the second codeword Z is decoded, whereby a reconstructed secret Sᵣ is created. The reconstructed secret value Sᵣ is cryptographically concealed by applying a cryptographic hash function F, and the cryptographically concealed reconstructed secret value F(Sᵣ) is compared with the cryptographically concealed secret value F(S) to check for correspondence, wherein the identity of the individual is verified if correspondence exists. As mentioned hereinabove, other combining functions than an XOR function may be employed in processing the second set W2 of helper data. If a modulo 7 operation is used to create the second set W2 of helper data, the second codeword Z would be calculated as Z=W2−Y′ mod 7.

A system that has some random factor in its production process, such that a response of the system to certain inputs is unique, is known in the art that and is often referred to as a Physical Uncloneable Function (PUF). From a signal processing point of view, biometric data can be seen as human a PUF. Throughout this application, the term “physical feature of the individual” (or similar terms) may optionally be replaced by the term “Physical Uncloneable Function”, in that data derived from the physical feature just as well may be data derived from a PUF.

In yet another embodiment of the present invention, reliable quantized feature components are selected by taking advantage of signal-to-noise (S/N) information for the quantized feature vectors X₁, X₂, . . . , Xₘ. Components having a signal-to-noise ratio that is considered to be sufficiently high are selected among the i reliable components of quantized feature vectors X₁, X₂, . . . , Xₘ. This way, noise (or intraclass variation) is taken into consideration in the selection of the relevant—i.e. reliable—components, and the subset j of reliable components chosen to create the first set of helper data W1 is no longer chosen randomly from the complete set i of reliable components.

As previously mentioned, an average value may be determined for each feature component by calculating the average value (over all enrollment measurements of all users) of the measured feature components that have the same position in the respective feature vectors. From each feature component of the individual, the corresponding determined average value is subtracted, and the result of the subtraction is quantized into a resolution of n bits.

It has been found that biometric templates of some individuals may be considered to be more reliable than the biometric templates of others. When considering S/N-information for the quantized feature vectors X₁, X₂, . . . , Xₘ (and thus indirectly for the biometric templates), the performance increases.

The signal-to-noise ratio is calculated as follows. Let X_{p,q} denote the q-th quantized feature vector that is derived from the biometric template of the p-th individual during the enrollment phase. This feature vector consists of k real-valued quantized components, where each quantized component has a resolution of n bits. (X_{p,q})ₜ denotes the t-th component of vector X_{p,q}. In the enrollment phase, f individuals are enrolled, and each individual is enrolled with m template measurements. First, the mean feature vector μₚ for each individual is calculated as follows:

$${\vec{μ}}_{p} = \frac{1}{m} {\sum }_{q = 1}^{m} {\vec{X}}_{p , q} .$$

Then, the mean feature vector μ for all individuals is calculated:

$$\vec{μ} = \frac{1}{f} {\sum }_{p = 1}^{f} {\vec{μ}}_{p} .$$

The signal-to-noise-ratio vector ξ is a vector (consisting of k components) of which the t-th component, denoted as (ξ)ₜ, is derived as follows:

$${( \overline{ξ} )}_{t} = \frac{{( \vec{σ} )}_{t}}{{( \vec{v} )}_{t}} .$$

Signal variance per component is expressed with vector σ and is calculated as;

$${( \vec{σ} )}_{t} = \frac{1}{f} {\sum }_{p = 1}^{f} {( {( {\vec{μ}}_{p} )}_{t} - {( \vec{μ} )}_{t} )}^{2} .$$

ν is a vector expressing the noise variance per component and is derived as follows:

$${( \vec{v} )}_{t} = \frac{1}{fm} {\sum }_{p = 1}^{f} {\sum }_{q = 1}^{m} {( {( {\vec{X}}_{p , j} )}_{t} - {( \vec{μ} )}_{t} )}^{2} .$$

In the reliable components scheme, each individual has a certain amount of reliable components, which amount differs for each individual. Preferably, a fixed amount i of components considered to be reliable is selected for each individual, and the first set W1 (comprising j components) of helper data is created from a subset of selected reliable quantized components, as described hereinabove. In the above, this subset i of reliable quantized feature components is randomly selected. However, in this particular embodiment, the selection of reliable components is made by selecting the j reliable components which have the highest corresponding signal-to-noise value (ξ)ₜ.

In still another embodiment of the present invention, performance is improved by dividing codeword C in blocks. As previously mentioned, a set X′ of data comprising the selected j reliable quantized feature components is created and a secret value S is generated and encoded to create the codeword C having a length equal to the set X′ of data comprising the selected reliable quantized feature components.

The secret S that is associated to a biometric is in the enrollment phase encoded with an error correcting code (ECC). The helper data W2 is created by applying a combining function (i.e. an XOR function) to the data set X′ and the code word C. An error correcting code may be denoted (N, K, T)-ECC, where N is word length, K is message length and T is error-correcting capability. For an ECC with a certain word length N, there is a tradeoff between K and T. For example, when considering a BCH code of length 512, only certain values for K and T are possible. For instance, two possible BCH codes are (N, K, T)=(511, 49, 93) and (N, K, T)=(511, 40, 95). The error correcting capability T must be chosen such that an optimal false acceptance rate (FAR) and false rejection rate (FRR) are achieved. Correcting more errors (e.g. 95 instead of 93) will lead to a shorter message length (40 instead of 49 bits) but also to a lower FRR and a slightly higher FAR, i.e. the length of the secret S to be encoded may be up to 40 bits. When more errors can be corrected, more noise is tolerated on the measurements of a single biometric template (i.e. a template of the same person). On the other hand, a measurement of a different template than the one that is enrolled has a greater chance of being accepted as correct, since a greater amount of errors is corrected. Ideally, the lowest FAR and FRR possible is to be achieved and typically, exactly the amount of errors that will lead to the situation where FRR=FAR is aimed at. At this point, the so-called equal error rate (EER) is achieved. Hence, the optimal value of number (T) of bits to correct is obtained when FRR=FAR.

Supposing that e.g. 85 of the 511 bits is to be corrected to achieve the EER, the scheme is bound to a message length of 76 bits (in case BCH codes are employed), since the best fitting code in this situation is the (N=511, K=76, T=85)-BCH code. However, this can be improved, especially if the errors in the previously mentioned verification set Y′ of selected reliable quantized feature components are more or less uniformly distributed over the set Y′. If T errors are to be corrected in the second, reconstructed codeword Z to achieve the EER, it is advantageous to divide the codeword C (and consequently also X′ and Y) into B blocks of which T/B errors per block must be corrected.

Encoding and decoding of shorter codes is more efficient in terms of computation time. Typically, encoding and decoding of two sets (i.e. B=2) of codes each comprising N/2 bits is more efficient than encoding and decoding of one code comprising N bits. Further, dividing the codeword C into subsets of codewords allow for better fine-tuning of coding parameters. For example, a 511-bit BCH code that corrects exactly 80 errors does not exist. However, this desired performance may roughly be achieved by employing code division such that two 255-bit BCH codes are employed that correct 42 errors each. In general, when dividing one code word into two smaller equal-length codewords, a few more bits than 0.5 times the number of bits must be corrected as compared to the number that must be corrected using a single codeword. Codeword division is particularly useful in low power devices such as smart cards.

Further features of, and advantages with, the present invention will become apparent when studying the appended claims and the following description. Those skilled in the art realize that different features of the present invention can be combined to create embodiments other than those described in the following. Further, those skilled in the art will realize that other helper data schemes than the scheme described hereinabove may be employed.

A detailed description of preferred embodiments of the present invention will be given in the following with reference made to the accompanying drawings, in which:

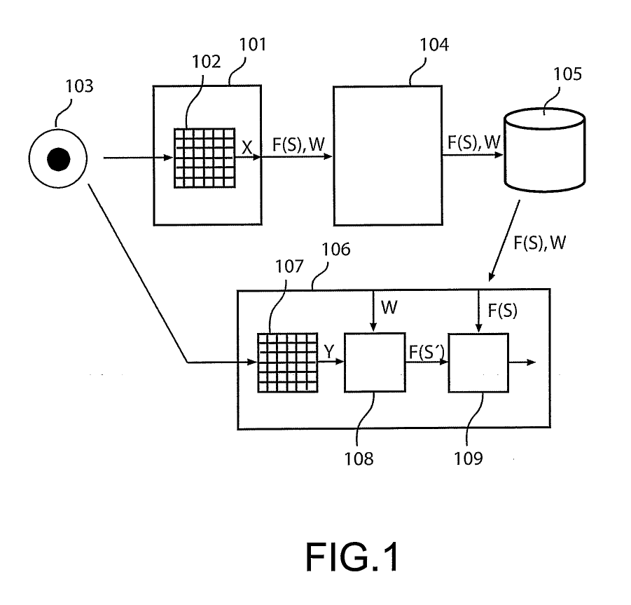

FIG. 1 shows a prior art system for verification of an individual's identity (i.e. authentication/identification of the individual) using biometric data associated with the individual; and

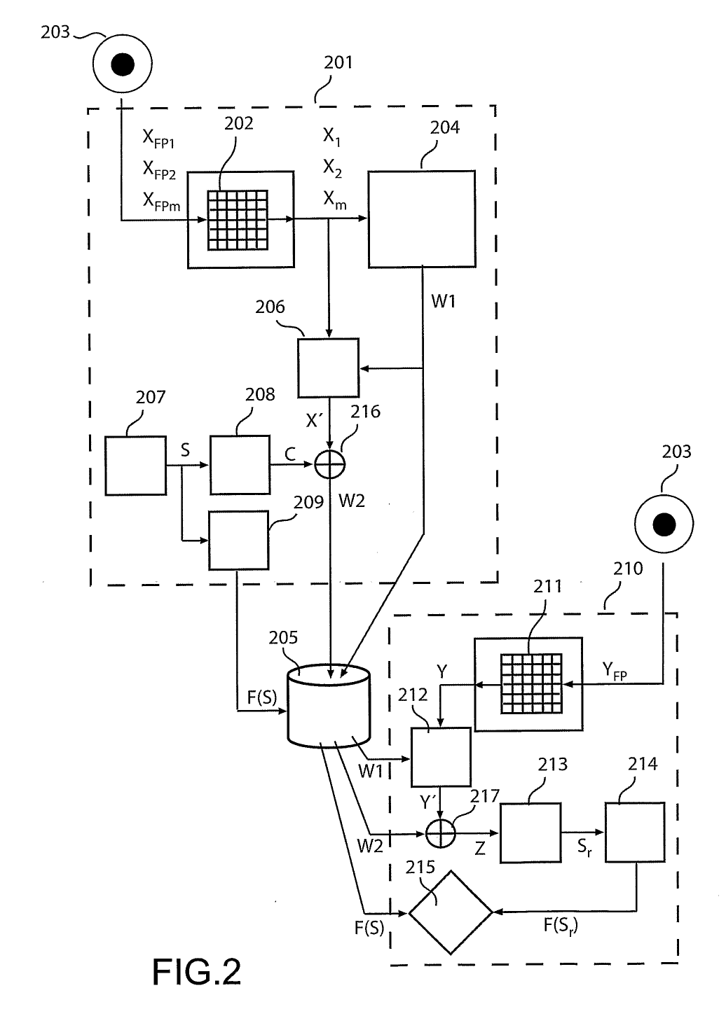

FIG. 2 shows a system for verification of an individual's identity using biometric data associated with the individual, according to an embodiment of the present invention.

FIG. 1 shows a prior art system for verification of an individual's identity (i.e. authentication/identification of the individual) using biometric data associated with the individual. The system comprises a user device 101 arranged with a sensor 102 for deriving a first biometric template X from a configuration of a specific physical feature 103 (in this case an iris) of the individual. The user device employs a helper data scheme (HDS) in the verification, and enrolment data S and helper data Ware derived from the first biometric template. The user device must be secure, tamper-proof and hence trusted by the individual, such that privacy of the individual's biometric data is provided. The helper data W is typically calculated at the user device 101 such that S=G(X, W), where G is a delta-contracting function. Hence, as W is calculated from the template X and the enrolment data S, G( ) allows the calculation of an inverse W=G⁻¹(X, S). This particular scheme is further described in “New Shielding functions to prevent misuse and enhance privacy of biometric templates” by J. P. Linnartz and P. Tuyls, AVBPA 2003, LNCS 2688.

An enrolment authority 104 initially enrolls the individual in the system by storing hashed enrolment data F(S) and the helper data W received from the user device 101 in a central storage unit 105, which enrolment data subsequently is used by a verifier 106. The enrolment data S is secret (to avoid identity-revealing attacks by analysis of S) and derived, as previously mentioned, at the user device 101 from the first biometric template X. At the time of verification, a second biometric template Y, which typically is a noise-contaminated copy of the first biometric template X, is offered by the individual 103 to the verifier 106 via a sensor 107. The verifier 106 generates secret verification data (S) based on the second set Y of biometric data and the helper data W received from the central storage 105. The verifier 106 authenticates or identifies the individual by means of the hashed enrolment data F(S) fetched from the central storage 105 and hashed verification data F(S) created at a crypto block 108. Noise-robustness is provided by calculating verification data S′ at the verifier as S′=G(Y, W). Thereafter, a hash function is applied to create the cryptographically concealed data F(S′). Even though the crypto block 108 is shown in FIG. 1 to be implemented as a separate block, it is typically included in the sensor 107, which generally is implemented at the verifier 106 as a secure, tamper-proof environment to hamper the verifier from obtaining the verification data S′. The delta-contracting function has the characteristic that it allows the choice of an appropriate value of the helper data W such that F(S′)=F(S), if the second set Y of biometric data sufficiently resembles the first set X of biometric data. Hence, if a matching block 109 considers F(S′) to be equal to F(S), verification is successful.

In a practical situation, the enrolment authority may coincide with the verifier, but they may also be distributed. As an example, if the biometric system is used for banking applications, all larger offices of the bank will be allowed to enroll new individuals into the system, such that a distributed enrolment authority is created. If, after enrollment, the individual wishes to withdraw money from such an office while using her biometric data as authentication, this office will assume the role of verifier. On the other hand, if the user makes a payment in a convenience store using her biometric data as authentication, the store will assume the role of the verifier, but it is highly unlikely that the store ever will act as enrolment authority. In this sense, we will use the enrolment authority and the verifier as non-limiting abstract roles.

As can be seen hereinabove, the individual has access to a device that contains a biometric sensor and has computing capabilities. In practice, the device could comprise a fingerprint sensor integrated in a smart card or a camera for iris or facial recognition in a mobile phone or a PDA. It is assumed that the individual has obtained the device from a trusted authority (e.g. a bank, a national authority, a government) and that she therefore trusts this device.

FIG. 2 shows a system for verification of an individual's identity using biometric data associated with the individual according to an embodiment of the present invention. Initially, during the enrolment phase, a plurality in of sets X_{FP} of biometric data associated with an individual 203 is derived by a sensor unit 202 at a user device or an enrolment authority 201. The user device typically comprises a microprocessor (not shown) or some other programmable device for performing the functions depicted by the different blocks in FIG. 2. The microprocessor executes appropriate software for performing these functions, which software is stored in a memory such as a RAM or a ROM, or on a storage media such as a CD or a floppy disc. Each biometric data set X_{FP} is represented by a feature vector, which comprises a number k of feature components. For a specific individual, a number m of measurements of the individual's physical feature is undertaken, which results in a corresponding number of sets X_{FP1}, X_{FP2}, . . . , X_{FPm} of biometric data and hence a corresponding number of feature vectors. Assuming that m=3 and k=5, the following exemplifying vectors are derived (in practice, m and particularly k will be considerably higher):

X_{FP1}=[1.1, 2.1, 0.5, 1.7, 1.2];

X_{FP2}=[1.1, 2.2, 0.6, 1.6, 1.2]; and

X_{FP3}=[1.2, 2.2, 0.6, 1.8, 1.1].

Thereafter, the components are quantized, and quantized feature vectors X₁, X₂, . . . , Xₘ (also comprising k components) are hence created. For each feature component, an average value is determined. The average value for each component is determined by calculating the average value of the measured feature components that have the same position in the respective feature vectors based on measured feature components pertaining to all individuals that are enrolled in the system. So in this example, based on the measurements of all enrolled individuals, the average value vector is:

X_{AV}=[1.1, 2.2, 0.6, 1.6, 1.2]

From each feature component of the individual, the corresponding determined average value is subtracted, and the result of the subtraction is quantized into a resolution of n bits. Consequently, if a one-bit resolution is employed (n=1), the resulting quantized feature component is assigned a value of 1 if the result of the subtraction is a value that is greater than 0. Correspondingly, if the result of the subtraction is a value that is equal to or less than 0, the resulting quantized feature component is assigned a value of 0. It should be noted that a higher quantization resolution could be used, as will be realized by the skilled person. Hence, using the above given average value vector X_{AV}, the result of the quantization will be:

X₁=[0, 0, 0, 1, 0];

X₂=[0, 0, 0, 0, 0]; and

X₃=[1, 0, 0, 1, 0].

Then, reliable components are selected by testing noise robustness of quantized feature components in robustness testing block 204. If, for the in different measurements of the biometric data of a particular individual, differences in the values of quantized feature components with the same position in the respective quantized feature vectors lies within a predetermined range, the quantized feature components are defined as reliable. Hence, if the values of the quantized feature components with corresponding locations in the quantized feature vectors are sufficiently close to each other, the quantized feature components (and thus the associated measured feature components) are considered reliable. For a quantization resolution of one bit, the quantized feature components with the same position in the respective quantized feature vectors must all be the same to be considered reliable. Other reliability measures can alternatively be used. For a quantization resolution of one bit, a component can be defined as reliable if, for example, a certain number of components selected from the total number of components (say 4 out of 5) at the same position in the feature vectors have the same value. In the above given example, three bits (i=3) are considered reliable.

The number i of reliable quantized feature components forms a set from which at least a subset of reliable quantized feature components is randomly selected. This subset comprises j reliable quantized components. Alternatively, the j components with the highest signal to noise ratio are selected, as described hereinabove. In this example, it is assumed that j=2, and that the components in positions number 2 and 5 are selected. The first set W1 of helper data is created from the indices of the selected reliable quantized components, i.e. the first set W1 of helper data is configured to comprise a number j of components, wherein each component in the first set of helper data is assigned a value that is equal to the position of the respective reliable quantized feature components in the sets X of quantized biometric data. Hence, the helper data W1 is a vector comprising the indices of the locations of the reliable quantized components that were randomly chosen:

W1=[2, 5]

and is stored in a central storage 205. The largest number of reliable quantized feature components that may be used to create the helper data W1 is attained when j=i. Thereafter, by using the first set W1 of helper data to select reliable components in any one of the quantized feature vectors X₁, X₂, . . . , Xₘ, a vector X′ of the selected reliable components is created in block 206, and this reliable component vector X′ thus comprises the j selected reliable quantized components:

X′=[0, 0].

A unique secret value S is associated with each individual's biometric data. This secret value may, for example, be generated by means of a random number generator (RNG) or, in practice, a pseudo random number generator (PRNG) 207. In order to provide noise robustness in the verification phase, the secret value S is encoded by encoder unit 208 into a codeword C of length j such that the codeword can be XORed at 216 with X′. The result of this XOR operation is a second set W2 of helper data, which also is centrally stored together with a hashed value F(S) of the secret value S created at a crypto block 209. The codeword C is defined as the codeword of an error correcting code. By performing an encoding operation, the randomly chosen secret S is mapped to the codeword C. Any type of appropriate error correction code can be used, e.g. Hamming codes or BCH codes (Reed-Solomon Codes). In an embodiment of the present invention, which has been described previously, the codeword C may be divided into a number B of subsets. Consequently, X′ must also be divided into the same number B of subsets. If the codeword C is divided into B subsets comprising different number of bits, X′ should also be divided into B subsets comprising the same number of bits, such that sets of data to be XORed with each other (i.e. C and X′) comprises the same number of bits.

In the verification phase, the individual provides a verification set Y_{FP} of biometric data to a verifier 210 comprising a sensor unit 211, which verification set Y_{FP} will be quantized in the same manner as the biometric data X_{FP} that was quantized in the enrolment process, i.e. by subtracting the determined average value from each component comprised in Y_{FP}, wherein the quantized biometric data vector Y comprising k components is created. The quantized biometric data provided in the verification phase will typically not be identical to the quantized data X₁, X₂, . . . , Xₘ provided in the enrolment phase, even though an identical physical property, for example the iris of the individual, is employed. This is due to the fact that when the physical property is measured, there is always random noise present in the measurement, so the outcome of a quantization process to convert an analog property into digital data will differ for different measurements of the same physical property. As an example, assume that the verification set is:

Y_{FP}=[1.2, 2.2, 0.5, 1.8, 1.1].

The quantized verification vector will hence become, after subtraction of X_{AV′}:

Y=[1, 0, 0, 1, 0].

The first set W1 of helper data is fetched from the central storage 205 and employed, in selection block 212 to select reliable components in the quantized feature vector Y, wherein another vector Y′ of selected reliable components is created, which reliable component vector Y′ comprises j components. This is enabled by the fact that the helper data W1 comprises the indices of the components that were considered reliable in the enrolment phase. Hence, these indices are employed to indicate reliable data in the quantized verification vector Y in that the helper data indicates components number 2 and 5. As a result:

Y′=[0, 0].

The second set W2 of helper data is fetched from the central storage and XORed at 217 with Y′. This results in a second codeword Z. In general, Y′ and X′ will be quite similar if the same fingerprint or PUF is used in the verification as in the enrolment. Therefore, the second codeword Z will be equal to the first codeword C, with some errors due to the intra-class variation (differences between several measurements of the same fingerprint or PUF) and noise, i.e. the second codeword Z can be seen as a noisy copy of the first codeword C. The codeword Z is decoded in decoding block 213 by employing an appropriate error correction code and this results in a reconstructed secret Sᵣ. A hashed copy F(Sᵣ) of the reconstructed secret Sᵣ is created in a crypto block 214 and compared with the centrally stored hashed copy F(S) of the secret value S in matching block 215 to check for correspondence. If they are identical, the verification of the identity of the individual is successful and the biometric system can act accordingly, for example by giving the individual access to a secure building. If the codeword C is divided into a number B of subsets, Y′ must also be divided into the same number B of subsets, since the second set W2 of helper data (which is based on the codeword C) is XORed with Y′ to create Z.

Note that different secret values may be generated for the same biometric template, and subsequently processed in the manner described hereinabove. For example, an individual may enroll herself at different companies/authorities. When generating different helper data vectors, a corresponding number of vectors of the selected reliable components will be generated. The encrypted different secret values will hence be XORed with the different vectors of the selected reliable components. Consequently, for a particular number of generated secret values, a corresponding number of different helper data pairs (W1, W2) will be created. This scheme may for example be preferred when an individual uses the same physical feature (or PUF) at two different verifiers. Although the same biometric template is used, two independent secret values can be associated to the same biometric such that one verifier does not acquire any information about the secret value that is used at the other verifier (related to the same biometric). This also prevents cross-matching of individuals, e.g. in that it prevents the verifiers from comparing their databases and hence revealing that data associated with a certain biometric data set in one database also is present in the other. Alternatively, the same secret value may be generated for different biometric templates (i.e. biometric templates pertaining to different individuals), and subsequently processed in the manner described hereinabove. When generating different helper data vectors, a corresponding number of vectors of the selected reliable components will be generated. The encrypted secret value of each individual will hence be XORed with the different vectors of the selected reliable components. This alternative scheme may be preferred if two or more individuals wish to use the same secret value, for example in a situation where a husband and wife share an account at the bank. The bank could encrypt information about their account with a single secret key, which can be derived from both the biometric data of the husband and the biometric data of the wife. Hence, the helper data associated with the biometric data of the wife can be selected in such a way that the resulting secret is the same as the secret associated to the biometric data of the husband.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method of verifying the identity of an individual by employing biometric data associated with the individual, the method providing privacy of said biometric data, the method comprising:
deriving a plurality of sets of biometric data associated with the individual, each set comprising a number of feature components;
quantizing the feature components of each set of derived biometric data, whereby a corresponding number of sets of quantized biometric data comprising a number of quantized feature components is created;
determining reliable quantized feature components by analyzing a noise robustness criterion, the criterion providing that differences in the values of feature components with the same position in the respective sets of quantized biometric data should lie within a predetermined range for the components to be considered reliable; and
creating a first set of helper data, which is to be employed in the verification of the identity of the individual, from at least a subset of said reliable quantized feature components; wherein processing of biometric data of the individual is performed in a secure, tamper-proof environment, which is trusted by the individual.

2. The method according to claim 1, further comprising:
determining an average value for each feature component by calculating the average value of the feature components that have the same position in the respective sets of biometric data associated with a plurality of individuals; and
subtracting the determined feature component average value from the corresponding feature components before performing the quantization.

3. The method according to claim 1 or 2, wherein the determining reliable quantized feature components comprises deriving signal-to-noise information for the sets of quantized biometric data to determine which reliable quantized feature components should be comprised in said subset to create the first set of helper data.

4. The method according to claim 3, wherein reliable quantized feature components having a signal-to-noise ratio that is considered to be sufficiently high are selected to be comprised in said subset to create the first set of helper data.

5. The method according to claim 3, wherein the signal-to-noise information is based on statistical calculations for the sets of quantized biometric data.

6. The method according to claim 5, wherein said statistical calculations are based on signal and noise variances in the quantized feature components.

7. The method according to claim 1, wherein the first set of helper data is configured to comprise a number of components, wherein each component in the first set of helper data is assigned a value that is equal to the position of the respective reliable quantized feature components in the sets of quantized biometric data.

8. The method according to claim 1, further comprising:
creating a set of data comprising the selected reliable quantized feature components;
generating a secret value and encoding the secret value to create a codeword, the codeword having a length equal to the set of data comprising the selected reliable quantized feature components;
creating a second set of helper data by combining the codeword and the set of data comprising the selected reliable quantized feature components; and
cryptographically concealing the secret value.

9. The method according to claim 8, wherein the secret value is encoded with an error correcting code.

10. The method according to claim 9, wherein the secret value is encoded with a BCH code.

11. The method according to claim 1, wherein the quantized biometric data set is encoded with a Gray code.

12. The method according to claim 8, wherein the data set comprising the selected reliable quantized feature component is encoded with a Gray code.

13. The method according to claim 1, further comprising deriving a verification set of biometric data associated with the individual, the set including a number of feature components, and quantizing the verification feature components into a verification set of quantized biometric data comprising a number of quantized feature components.

14. The method according to claim 13, further comprising the step of selecting reliable components in the verification set of quantized biometric data, the reliable components being indicated by the first set of helper data, wherein a verification set of selected reliable quantized feature components is created.

15. The method according to claim 14, further comprising dividing the first codeword, the data set comprising the selected reliable quantized feature components and the verification set of selected reliable quantized feature components respectively into at least two subsets of data.

16. The method according to claim 14, further comprising:
creating a second codeword by combining the second set of helper data and the verification set of selected reliable quantized feature components; and
decoding the second codeword, whereby a reconstructed secret value is created.

17. The method according to claim 16, further comprising:
cryptographically concealing the reconstructed secret value;
comparing the cryptographically concealed reconstructed secret value with the cryptographically concealed secret value to check for correspondence, wherein the identity of the individual is verified if correspondence exists.

18. The method according to claim 8, wherein said combining is performed by performing an XOR operation.

19. The method according to claim 8, further comprising:
creating further sets of helper data to be employed in the verification of the identity of the individual, from said at least a subset of said reliable quantized feature components, and creating further respective sets of data comprising the selected reliable quantized feature components; and
generating further secret values to be processed with the further sets of data comprising the selected reliable quantized feature components.

20. The method according to claim 19, wherein different sets of helper data are stored in different storage means.

21. The method according to claim 8, further comprising generating the same secret value for different individuals.

22. The method according to claim 1, further comprising storing the first set of helper data, the second set of helper data and the cryptographically concealed secret value in a central storage.

23. A system for verifying the identity of an individual by employing biometric data associated with the individual, the system providing privacy of said biometric data, the system comprising:
means for deriving a plurality of sets of biometric data associated with the individual, each set comprising a number of feature components, and for quantizing the feature components of each set of derived biometric data, whereby a corresponding number of sets of quantized biometric data comprising a number of quantized feature components is created;
means for determining reliable quantized feature components by analyzing a noise robustness criterion, the criterion providing that differences in the values of feature components with the same position in the respective sets of quantized biometric data should lie within a predetermined range for the components to be considered reliable, and for creating a first set of helper data, which is to be employed in the verification of the identity of the individual, from at least a subset of said reliable quantized feature components; wherein
the system is arranged such that processing of biometric data of the individual is performed in a secure, tamper-proof environment, which is trusted by the individual.

24. The system according to claim 23, wherein the deriving means is arranged to determine an average value for each feature component by calculating the average value of the feature components that have the same position in the respective sets of biometric data associated with a plurality of individuals, and to subtract the determined feature component average value from the corresponding feature components before performing the quantization.

25. The system according to claim 23, wherein the means for determining reliable quantized feature components further is arranged to derive signal-to-noise information for the sets of quantized biometric data to determine which reliable quantized feature components should be comprised in said subset to create the first set of helper data.

26. The system according to claim 25, wherein the means for determining reliable quantized feature components is arranged to select reliable quantized feature components, the components having a signal-to-noise ratio that is considered to be sufficiently high, to be comprised in said subset to create the first set of helper data.

27. The system according to claim 25, wherein the signal-to-noise information is based on statistical calculations for the sets of quantized biometric data.

28. The system according to claim 27, wherein said statistical calculations are based on signal and noise variances in the quantized feature components.

29. The system according to claim 23, wherein the determining means is arranged to configure the first set of helper data is such that it comprises a number of components, wherein each component in the first set of helper data is assigned a value that is equal to the position of the respective reliable quantized feature components in the sets of quantized biometric data.

30. The system according to claim 23, further comprising:
means for creating a set of data comprising the selected reliable quantized feature components;
means for generating a secret value;
means for encoding the secret value to create a codeword, the codeword having a length equal to the set of data comprising the selected reliable quantized feature components; and
means for creating a second set of helper data by combining the codeword and the set of data comprising the selected reliable quantized feature components; and
means for cryptographically concealing the secret value.

31. The system according to claim 30, wherein the means for encoding the secret value is arranged to perform the encoding with an error correcting code.

32. The system according to claim 31, wherein the means for encoding the secret value is arranged to perform the encoding with a BCH code.

33. The system according to claim 23, wherein the means for creating a data set comprising the selected reliable quantized feature components is arranged to encode the quantized biometric data set with a Gray code.

34. The system according to claim 23, wherein the means for creating a data set comprising the selected reliable quantized feature components is arranged to encode the data set comprising the selected reliable quantized feature components with a Gray code.

35. The system according to claim 23, further comprising means for deriving a verification set of biometric data associated with the individual, the set including a number of feature components, and quantizing the verification feature components into a verification set of quantized biometric data comprising a number of quantized feature components.

36. The system according to claim 35, further comprising means for selecting reliable components in the verification set of quantized biometric data, the reliable components being indicated by the first set of helper data, wherein a verification set of selected reliable quantized feature components is created.

37. The system according to claim 36, further comprising means for dividing the first codeword, the data set comprising the selected reliable quantized feature components and the verification set of selected reliable quantized feature components respectively into at least two subsets of data.

38. The system according to claim 36, further comprising:
means for creating a second codeword by combining the second set of helper data and the verification set of selected reliable quantized feature components; and
means for decoding the second codeword, whereby a reconstructed secret value is created.

39. The system according to claim 38, further comprising:
means for cryptographically concealing the reconstructed secret value;
means for comparing the cryptographically concealed reconstructed secret value with the cryptographically concealed secret value to check for correspondence, wherein the identity of the individual is verified if correspondence exists.

40. The system according to claim 29, wherein the means for combining comprise an XOR function.

41. The system according to claim 29, wherein:
the determining means is arranged to create further sets of helper data, which is to be employed in the verification of the identity of the individual, from said at least a subset of said reliable quantized feature components;
the means for creating a set of data comprising the selected reliable quantized feature components is arranged to create further respective sets of data comprising the selected reliable quantized feature components; and
the means for generating a secret value is arranged to generate further secret values to be processed with the further sets of data comprising the selected reliable quantized feature components.

42. The system according to claim 41, wherein different sets of helper data are stored in different storage means.

43. The system according to claim 29, wherein the means for generating a secret value is arranged to generate the same secret value for different individuals.

44. The system according to claim 23, further being arranged to store the first set of helper data, the second set of helper data and the cryptographically concealed secret value in a central storage.

45. A computer program, embodied in a computer readable medium, for verifying the identity of an individual by employing biometric data associated with the individual, comprising:
deriving a plurality of sets of biometric data associated with the individual, each set comprising a number of feature components;
quantizing the feature components of each set of derived biometric data, whereby a corresponding number of sets of quantized biometric data comprising a number of quantized feature components is created;
determining reliable quantized feature components by analyzing a noise robustness criterion, the criterion providing that differences in the values of feature components with the same position in the respective sets of quantized biometric data should lie within a predetermined range for the components to be considered reliable; and
creating a first set (W1) of helper data, which is to be employed in the verification of the identity of the individual, from at least a subset (j) of said reliable quantized feature components, wherein processing of biometric data of the individual is performed in a secure, tamper-proof environment, which is trusted by the individual.
